(19) United States
(12) Patent Application Publication
(10) Pub. No.: US 2026/0335693 A1
(43) Pub. Date: Oct. 29, 2026

(54) FIRE SPRINKLER HEAD MOISTURE COLLECTION APPARATUS AND METHOD OF USE

(71) Applicant: Robert WOLVERTON, Cocoa Beach, FL (US)

(72) Inventor: Robert WOLVERTON, Cocoa Beach, FL (US)

(21) Appl. No.: 19/700,262

(22) Filed: Jun. 6, 2026

(51) Int. Cl. A62C 37/50; G01M 3/04

(52) U.S. Cl. CPC A62C 37/50; G01M 3/04

(57) ABSTRACT

apparatus and method of use. The apparatus includes a condensation forming or water leak alert component and a moisture collection component. The moisture alert component alerts a user that condensation is forming on the fire sprinkler head or that water is leaking from the fire sprinkler head with a change in color or via condensation or water leaking from the fire sprinkler head causing a change in state (e.g., stretches in length, etc.). The moisture collection components collect condensation and water that is leaking from fire sprinkler heads. The apparatus is attached to fire sprinkler heads without interfering with an operation the fire sprinkler head in a fire event requiring use of the fire sprinkler head.

### CROSS REFERENCE TO RELATED APPLICATIONS

Not Applicable.

### FIELD OF INVENTION

This patent application relates to fire sprinklers. More specifically, it relates to moisture collection for fire sprinkler heads.

### BACKGROUND OF THE INVENTION

Condensation forms when warm, humid air hits a surface that is cooler than a dew point.

A dew point is temperature at which air becomes fully saturated with moisture (i.e., 100% relative humidity) and cannot hold any more water vapor, so that water vapor starts turning into a liquid called “condensation.”

Condensation around fire sprinkler heads in an apartment, townhouse, condominium, commercial office and/or other commercial spaces is common in warm, humid climates.

Condensation occurs around fire sprinkler heads in warm, humid climates because ventilation in such spaces is not adequate and the fire sprinkler head is made of a metal material (e.g., metals, etc.), that is often cooler than surrounding ceiling materials such as drywall, plaster, etc. As a result, moisture forms on and/or around the fire sprinkler head.

In warm humid climates, air conditioning units cool air in an apartment, townhouse and/or condominium but do not always remove all humidity. If indoor humidity stays above about 55% to about 60%, condensation begins to occur and even slightly cooler surfaces, like fire sprinkler heads, start developing condensation on their metallic surfaces.

There are a number of problems associated with condensation on fire sprinkler heads in such spaces.

One problem is that such condensation from fire sprinkler heads causes persistent dripping in such spaces on areas underneath and surrounding areas causing water damage to furniture, carpets, other flooring, household possessions, etc.

Another problem is that such condensation from such fire sprinkler heads causes constant wetness and mold to develop on such furniture, carpets, other flooring, household possessions, etc.

Mold such as Cladosporium, Aspergillus, Stachybotrys chartarum, which is referred to as “black mold” and/or other species of mold can trigger, allergies, sinus irritation, asthma symptoms in sensitive individuals, shortness of breath, fatigue and other short term and/or long-term chronic health problems in individuals occupying spaces where condensation is forming on such fire sprinkler heads. Over time, exposure to such mold species can lead to permanent lung damage (e.g., fibrosis, etc.) if not addressed. Fibrosis is the formation of excess scar tissue in an organ such as the lungs after repeated injury or chronic inflammation.

Another problem is that such condensation causes such mold to form in and around a ceiling area including the fire sprinkler head.

Another problem is that most fire sprinkler heads do not include a leak alert apparatus that alerts a person to a water leak from a fire sprinkler head that is not activated by condensation on the fire sprinkler heads.

Another problem is that water leaks commonly occur around such fire sprinkler heads, especially in older buildings.

There have been attempts to solve some of the problems associated with condensation around fire sprinkler heads in living spaces and commercial spaces.

For example, U.S. Pat. No. 2,890,758, that issued to Pfalzgraff et al. teaches “The invention comprises essentially the provision of a drawn synthetic plastic cap securely, mounted and covering the individual sprinkler head nozzle. The preferred form of cap is hemispherical in shape and provides substantial clearance between the sprinkler head and the inside of the cap. Another embodiment uses a cylindrical cap more closely fitting the sprinkler head and provided with portions of reduced thickness, as by scoring, and a weight which together cooperate to completely remove the lower portion of the cap when the portions. of reduced thickness give way under elevated temperature conditions. The material found to be highly satisfactory for making such caps is a nitrocellulose composition.”

U.S. Pat. No. 3,727,695 that issued to Danton teaches “An apparatus for preventing tampering with automatic fire extinguisher sprinkler heads of the type which use a temperature responsive element for activating the sprinkler head when a predetermined temperature is reached. The apparatus comprises a collar which is attached to the sprinkler head, a cover which cooperates with the collar to completely enclose the temperature responsive element of the sprinkler head, and a plurality of struts which interconnect the cover and the collar. The struts are attached to the inner walls of the cover by fusible connectors which are adapted to fail at a predetermined temperature, thereby allowing the cover to separate from the collar. A spring member is interposed between the sprinkler head and the cover so that when the fusible connectors fail at a predetermined increase in temperature the cover will be ejected free of the sprinkler head.”

U.S. Pat. No. 4,747,366, that issued to Walker teaches “A device for protecting the beauty rims of ceiling-mounted water sprinklers comprises a shield member having a closed end removably attached to one end of an elongate handle. The shield member has an open end terminating in a flared lip, the interior surface of which is provided with a ring of adhesive material. The method of using the device includes the steps of (a) attaching the closed end of the shield member to the handle end; (b) placing the open end of the shield member over the sprinkler to cover the sprinkler and the rim, whereby the adhesive material adheres to the rim; (c) removing the handle from the closed end of the shield member, leaving the shield member attached to the rim by the adhesive material; (d) painting the ceiling around the shield member; and (e) removing the shield member from the rim.”

U.S. Pat. No. 5,097,906, that issued to Polan teaches “A concealed frame-type automatic sprinkler with adjustable cover is provided by a sprinkler with a sprinkler body, an outlet on one side of the sprinkler body, a frame which extends from the body completely around the outlet, a plug retained in the outlet by a heat-sensitive element, and a pair of spring clips retained on the sprinkler by an adjustment screw passed through the frame to preload the heat-responsive element against the plug. The clip members are diametrically opposed and extend radially outwardly on either side of the frame. Each includes a pair of arms with tabs sized and positioned to engage with ribs provided on an inner cylindrical surface to a central cylindrical bracket member provided on an inner side of the cover. A gauge bracket may be mounted on the sprinkler to assure a deflector of the sprinkler is located at a proper height with respect to the ceiling through which the sprinkler extends.”

U.S. Pat. No. 6,641,059, that issued to Waligorski, et al. teaches “releasable protective cover assembly for a sprinkler head is activated by heat and substantially immune to damage from blows and inappropriate use due to its dome shape, which deflects attempts to damage the cover or to abuse the sprinkler head.”

U.S. Pat. No. 7,540,330, that issued to Orr, et al. teaches, “A sprinkler head cover including an end wall and a side wall extending from and around the end wall to form a cavity therebetween. The cavity is sized for receiving a deflector and arms of a sprinkler head. The side wall is adapted for engaging the sprinkler head to thereby releasably mount the cover to the sprinkler head.”

U.S. State Design Patent, USD662569S1, that issued to McKay, et al. teaches “a cover placed on a ceiling over a fire sprinkler head.”

U.S. Published Patent Application US20260034555A1, published by Cook, et al. teaches “A high-temperature fire sprinkler shield with integrated magnetic coupling provides advanced protection for fire sprinkler heads in high-heat environments. Constructed from durable silicone with a thickness of 1.5 mm to 4 mm, this cover offers superior thermal insulation and resistance. The unitary body features a cylindrical sidewall extending from a planar base, creating a hollow cavity that encloses the sprinkler head. An integrated magnetic attachment mechanism ensures a secure and easy fit to the metallic bezel of the sprinkler, maintaining stability and thermal isolation. This invention addresses the limitations of traditional covers by effectively safeguarding sprinkler heads from heat-induced damage and accidental activation.”

U.S. Published Patent Application US20140361100A1, published by Hunsberger, teaches “A sprinkler head protection arrangement is provided having a first plate which is connected to a pipe providing fluid to flow through the plate, a sprinkler head mounted in the first plate to receive and control the fluid flow, and a second plate removably clamped to the first plate with a rigid cage mounted thereon to surround and protect the sprinkler head. The cage is formed from rigid links and rings which resist impact deformation. The second plate is secured to the first plate with minimal fasteners. An impact force absorbing spacer can be mounted between the plates. The sprinkler head can be further separated from impact forces by connecting to the first plate through a sleeve or bushing.”

U.S. Published Patent Application Number US20120267453A1, published by Devany, teaches “A sprinkler protection system for protecting an existing sprinkler installation includes housing sections that cooperate to cover a majority of a sprinkler unit, such as a ceiling-mounted sprinkler unit. The housing sections can include one or more apertures aligned with a deflector of the sprinkler to permit the deflector to direct water through the aperture and out of the housing without significantly impeding the water output of the sprinkler and offer greater protection to the sprinkler unit.”

However, none these solutions solve all of the problems associated with condensation and water leaks associated with fire sprinkler heads. Thus, it is desirable to solve some of the problems associated with condensation and moisture around fire sprinkler heads.

### SUMMARY OF THE INVENTION

In accordance with preferred embodiments of the present invention, some of the problems associated with condensation around and water leaks from fire sprinkler heads are overcome. A fire sprinkler head moisture collection apparatus and method of use is presented.

The apparatus includes a water leak alert component and a moisture collection component. The moisture alert component alerts a user that condensation is forming on the fire sprinkler head or that water is leaking from the fire sprinkler head with a change in color or via condensation or water leaking from the fire sprinkler head causing a change in state (e.g., stretches in length, etc.). The moisture collection components collect condensation and water that is leaking from fire sprinkler heads. The apparatus is attached to fire sprinkler heads without interfering with the operation of the fire sprinkler head in a fire event requiring use of the fire sprinkler head.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating an exploded view of an exemplary fire sprinkler head and fire sprinkler head moisture collection apparatus;

FIG. 2 is a block diagram illustrating a side view and a top view of a moisture alert component in an exemplary fire sprinkler head moisture collection apparatus;

FIG. 3 is a block diagram illustrating a side view of a transparent moisture collection component attached to water leak alert component in an exemplary fire sprinkler head moisture collection apparatus;

FIG. 4 is a block diagram illustrating a side view of a stretched transparent membrane of the moisture collection component attached to moisture alert component in an exemplary fire sprinkler head moisture collection apparatus during a first non-fire moisture collection event on an existing fire sprinkler head;

FIG. 5 is a block diagram illustrating a side view of a stretched transparent membrane component of the moisture collection component attached to moisture alert component in an exemplary fire sprinkler head moisture collection apparatus during a second non-fire water leak collection event on an existing fire sprinkler head;

FIG. 6 is a block diagram illustrating a side view of a stretched transparent membrane component of the moisture collection component attached to moisture alert component in an exemplary fire sprinkler head moisture collection apparatus during a third non-fire condensation moisture and/or water leak collection event on an existing fire sprinkler head;

FIG. 7 is a block diagram illustrating a side view of transparent membrane component of the moisture collection component attached to moisture alert component in an exemplary fire sprinkler head moisture collection apparatus during a fire event on an existing fire sprinkler head; and

FIG. 8 is a flow diagram illustrating a method of use of a fire sprinkler head moisture collection apparatus.

### DETAILED DESCRIPTION OF PREFERRED EMBODIMENTS

Exemplary Fire Sprinkler Head Moisture Collection Apparatus

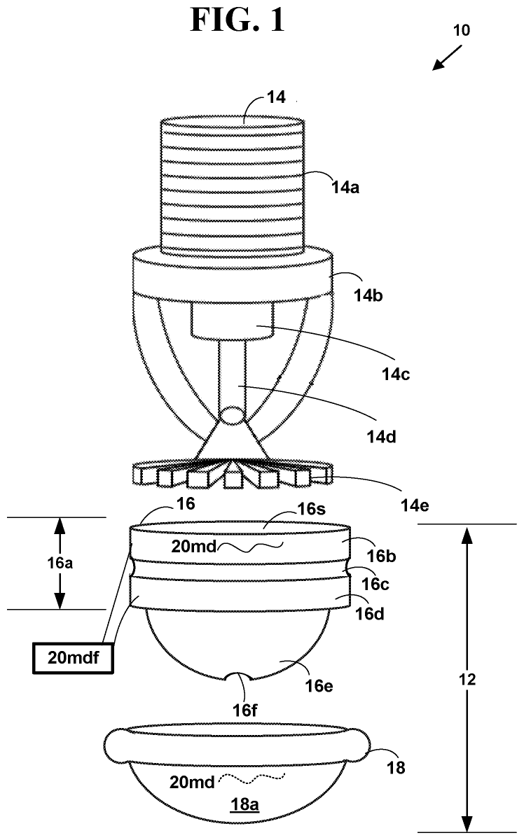

FIG. 1 is a block diagram illustrating an exploded view of an exemplary fire sprinkler head 14 and fire sprinkler head moisture collection apparatus 12.

In FIG. 1, the fire sprinkler head 14 is illustrated as being placed in a ceiling in a space and occurs in a vertical fire head configuration.

A fire sprinkler head 14 is a heat-activated valve that opens only when a fire raises a temperature at that specific location of the fire sprinkler head 14. A fire sprinkler head includes, a threaded component 14a, that connects it to a pressured water system, a frame component 14b connected to the threaded component 14a, a plug seal component 14c that prevents water from flowing from the water system, a temperature-sensitive trigger component 14d, including a glass bulb (that shatters) and/or a metal fusible link (that melts) and a deflector component 14e that spreads water in a spray pattern during a fire event.

The temperature-sensitive trigger component 14d, includes a glass bulb that includes a liquid (e.g., a glycerin-based solution, etc.) that is dyed to indicate an activation temperature, etc.) that expands when at a predetermined temperature, increasing a pressure inside the glass bulb until the glass shatters and/or a metal fusible link that melts at a predetermined temperature, (e.g., tin-based alloys, etc.) that have low-melting-points.

In one embodiment, the predetermined temperature that triggers the temperature-sensitive trigger component 14 d is about 135 to about 165 degrees Fahrenheit (°F) (or about 57 to about 74 degrees Celsius (°C)).

Once the glass bulb shatters and/or the metal fusible link melts of the temperature-sensitive trigger component 14d, water pressure pushes the plug seal component 14c out and water flows immediately from the pressured water system in a downward direction via a water pressure flow and via gravity. The water hits the deflector component 14e and spreads the water in a specific spray pattern to cool fire, wet the materials under the fire sprinkler head 14 and prevent the fire from spreading.

Water has a high heat absorbing capacity and will quicky cool a fire. Water is applied as a spray pattern as water droplets, not a solid stream to increase cooling efficiency and surface coverage. Most fires are controlled with just one or two fire sprinkler heads 14.

In FIG. 1, the fire sprinkler head moisture collection apparatus 12 includes, but is not limited to, a moisture alert component, configured for collecting condensation moisture and leaked water from a fire sprinkler head, comprising: a flange component 16a of a pre-determined diameter, length, width, shape and material to fit on a bottom portion of a deflector component 14e on the fire sprinkler head 14, the flange component 16a including a first section 16b, a second section 16c and a third section 16d, the second section 16c including a recessed surface comprising a groove component, the flange component further including a dome component 16e for directing the condensation moisture and the leaked water from the fire sprinkler head 14 into a receptacle component 16f extending through a bottom surface of the dome component 16e; the receptacle component 16f for directing the condensation moisture and the leaked water from the fire sprinkler head 14 into a moisture collection component 18, the moisture alert component 16 changing from a first alert state to a second alert state when condensation moisture or leaked water is received from the fire sprinkler head 14; the moisture collection component 18, configured for collecting the condensation moisture and the leaked water from the receptacle component 16f of the moisture alert component 18, comprising: a transparent water-tight, stretchable, elastic membrane 18a configured for collecting and holding the condensation moisture and the leaked water from the receptacle component 16f of the moisture alert component 16, the moisture collection component 18 changing from a first collection state to a second collection state when the condensation moisture or the leaked water is collected from the receptacle component 16f of the moisture alert component 16, the moisture collection component 18 changing from the first collection state to the second collection state without interfering with the operation of the deflector component of the fire sprinkler head 14 during the fire event in a first space underneath the fire sprinkler head 14; and the moisture alert component 16 and moisture collection component 18 changing states upon receiving the condensation moisture or the leaked water from the fire sprinkler head without interfering with the operation of the deflector component during non-fire events of the fire sprinkler head 14, and the moisture alert component 16 and the moisture collection component 18 collecting the condensation moisture or the leaked water from the fire sprinkler head 14 preventing the first space underneath the fire sprinkler head 14 from becoming wet and creating first environmental space in which one or more species of mold can grow, and preventing a second space around the fire sprinkler head 14 from becoming wet and creating a second environmental space in which one or more species of mold can grow.

In one embodiment, a moisture detecting compound 20md is used with the fire sprinkler head moisture collection apparatus 12 to detect condensation moisture and leaked water from the fire sprinkler head 14. The moisture detecting compound 20md changes states from a first state when dry to a second state when moisture is detected (e.g., changes from a first color to a second color, etc.) However, the present invention is not limited to such an embodiment and other embodiments, with and/or without using the moisture detecting compound 20md can be used to practice the invention.

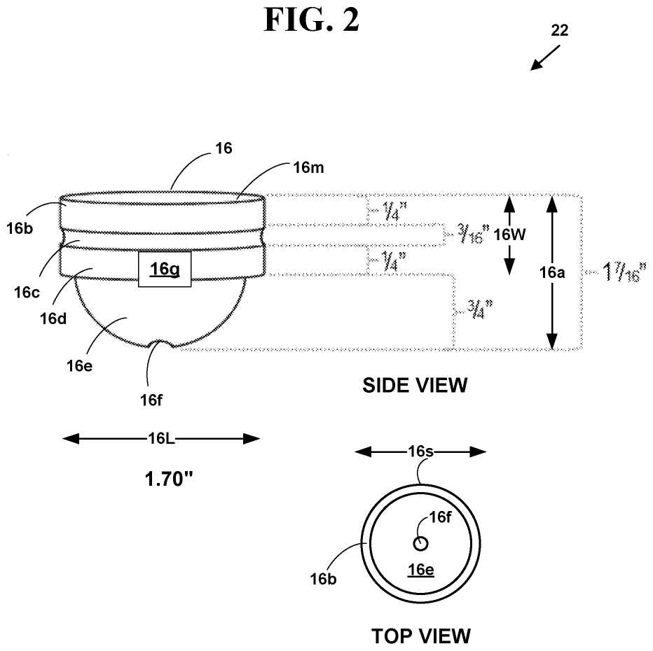

FIG. 2 is a block diagram 22 illustrating a side view and a top view of a moisture alert component 16 in an exemplary fire sprinkler head moisture collection apparatus 12.

The moisture alert component 16, includes but is not limited to, the flange component 16a of a pre-determined diameter 16m, length 16g, width 16b, 16c, 16d, shape 16s circular and/or oval and shape to fit on a bottom portion of the deflector component 14e of fire sprinkler head 14, with the dome component 16e and the receptacle 16f in the moisture alert component 16 for draining water and condensation through the dome component 16e via the receptacle component 16f.

A flange includes a projecting rim, collar, or lip on a part that's used to connect, support, align, or seal it to another component.

A typical fire sprinkler head 14 includes a deflector component 14e with a diameter of about 1.5 inches to about 2.5 inches (about 38-64 millimeters (mm)).

FIG. 2 illustrates exemplary sizes and measurements of the moisture alert component 16. However, the present invention is not limited to such sizes and measurements and other sizes and measurements can be used to practice the invention.

In FIG. 2 in one embodiment, the flange component 16a, with the leak alert dome component 16b, includes but is not limited to, circular and/or oval shape with pre-determined diameter 16m of about 1.6 inches to about 2.6 inches (about 40 mmto about 66 mm), a pre-determined size slightly larger than the fire sprinkler head to fit around the fire sprinkler deflector head 14e, and engage, fit snuggly, and securely and attach to the fire sprinkler head 14 (FIG. 1). However, the present invention is not limited to such an embodiment, and other sizes can be used to practice the invention.

In one embodiment, a pre-determined length 16L of the flange component 16b, 16d, 16c includes a length of about 11/16 inches (0.6875 inches or about 17.4625 mm). However, the present invention is not limited to such an embodiment, and other sizes can be used to practice the invention.

In one embodiment, a pre-determined width 16W of the flange component 16b, 16c, 16d includes a width of about 1.7 inches to about 2.7 inches (about 43.18 mm to about 68.58 mm), just slightly larger in size than the pre-determined diameter 16m. However, the present invention is not limited to such an embodiment, and other sizes can be used to practice the invention.

In one embodiment, the leak alert dome component 16b includes a width of about three-fourth inches (about 19 mm) and a length of about 1.6 inches to about 2.6 inches (about 40.64 mm to about 66.04 mm). However, the present invention is not limited to such an embodiment and other sizes can be used to practice the invention.

In one embodiment, the flange component 16a, with the leak alert dome component 16e includes a total length of about one and seven-sixteenths inches (about 36.5 mm) (FIG. 2). However, the present invention is not limited to such an embodiment, and other sizes can be used to practice the invention.

In one embodiment, the moisture alert component 16, includes but is not limited to, a comprising wood, rubber, paper, plastics, composite materials and/or other materials, and/or combinations thereof. However, the present invention is not limited to such materials, more, fewer and/or other materials can be used to practice the invention.

The paper includes, but is not limited to, cardstock, thick paper commonly used for business cards, invitations, packaging, and covers; cover stock, similar to cardstock but often specified for printing applications; Bristol board, very stiff, smooth paper used for illustration, drafting, and signage; tag board, durable stiff paper used for tags, folders, and file dividers; chipboard, recycled, dense paperboard often used in packaging and backing boards; matt board, thick decorative board used in picture framing; corrugated cardboard, multi-layer paperboard with a fluted center layer used in boxes; and/or fiberboard, dense engineered paper material used for structural packaging. However, the present invention is not limited to such paper materials, more, fewer and/or other paper materials can be used to practice the invention.

The wood, includes, but is not limited to, bamboo, white oak, maple, hickory, ash, beech and/or other natural occurring woods with high strength, tight grain, and dimensional stability. The wood also includes laminated wood materials. Laminated wood is an engineered material made by bonding multiple thin layers (i.e., laminations, etc.) of wood together with adhesive to create a single, stronger and more stable piece.

The rubber includes, but is not limited, to natural rubber and synthetic rubbers. Naturally occurring rubber is an elastic material obtained from the milky sap, called latex of rubber trees. Synthetic rubber includes man-made elastic polymers (elastomers) designed to mimic or exceed the properties of natural rubber. Instead of plant latex, synthetic rubber is produced by polymerizing petrochemical monomers into long, flexible chains. Synthetic rubber includes elastomeric compounds that comprises various monomer units forming polymers that are heat cured (i.e., vulcanized, etc.). Polymers are long molecular chains that are connected together (i.e., cross-linked, etc.) to improve their toughness and resilience. The base monomer (or monomers, when blended) is used to classify a type of rubber. For example: Neoprene, SBR or Nitrile.

The plastics include, but are not limited to, Polyvinyl chloride (PVC), Very low-density polyethylene (VLDPE), Flexible polypropylene (FPP), Ethylene interpolymer alloy (EIA), ethylene propylene diene monomer (EPDM) and/or other types of plastics, or combinations thereof.

Polyvinyl chloride (PVC) is durable, cheap, and easily worked into membranes. Polyvinyl chloride is produced by polymerization of a monomer, vinyl chloride (VCM). PVC's are relatively low cost, biological and chemical resistance and very workable into membranes.

Very low-density polyethylene (VLDPE) and linear low-density polyethylene (LLDPE) overcome the shortcomings of other polyethylenes (e.g., high density polyethylene (HDPE), etc. in terms of flexibility. These are less crystalline forms of polyethylene which result in increased flexibility and a membrane less conducive to brittle stress cracking.

Flexible polypropylene (FPP) is produced in both unreinforced (PPU) and reinforced (PPR) form to provide a choice in terms of tensile behavior.

Ethylene interpolymer alloy (EIA) is an alloy of PVC resin with a special ethylene interpolymer that results in a flexible plastic-free material. EIA geomembranes maintain the advantages of PVC but have a high degree of durability and chemical resistance.

Ethylene propylene diene monomer (EPDM) was developed from butyl rubber and exhibits excellent elongation characteristics. “Composite materials” are engineered or naturally occurring materials made from two or more constituent materials with significantly different physical or chemical properties which remain separate and distinct at the macroscopic or microscopic scale within the finished structure. Common polymer-based composite materials include at least two parts, a substrate (e.g., fibers, etc.) and a resin.

The composite materials include Fiber-reinforced polymers (FRP) including thermoplastic composites, short fiber thermoplastics, long fiber thermoplastics or long fiber-reinforced thermoplastics. There are numerous thermoset composites, but advanced systems usually incorporate aramid fiber and carbon fiber in an epoxy resin matrix. The composite materials also include carbon/carbon composite materials with carbon fibers and/or a silicon carbide matrix.

However, the present invention is not limited to these materials and other materials can be used to practice the invention.

In one embodiment, an outer surface of the moisture alert component 16 is coated with a moisture detecting compound 20md. However, the present invention is not limited to such an embodiment and other embodiments can be used to practice the invention.

In another embodiment, a fabric moisture detecting material 20mdf is placed around the first section 16b and/or the third section 16d of the flange component 16a to provide a visual moisture alert indicator. The fabric moisture detecting material 20mdf includes a cloth, rubber, plastic, paper, wood and/or other moisture detecting material 20mdf. However, the present invention is not limited to these embodiments, and other embodiments can be used to practice the invention.

In one embodiment, the moisture alert component 16 further includes a clear plastic component and/or a component with a clear plastic window 16g (FIG. 2). In such an embodiment, the clear plastic window 16g of the moisture alert component 16 is coated on an inside surface with a moisture detecting compound 20md that changes color when moisture is detected. However, the present invention is not limited to these embodiments, and other embodiments can be used to practice the invention.

In one embodiment, the moisture detecting material 20mdf includes a coating comprising the moisture detecting compound 20md. However, the present invention is not limited to these embodiments, and other embodiments can be used to practice the invention.

The moisture detecting compound 20md includes but is not limited to: Hydrochromic inks, Cobalt (II) chloride, Cobalt (II) bromide, Silica gel coating, Copper (II) Sulfate coating, methyl violet, hydrogel polymers, polyvinyl alcohol, cellulose coatings and/or combinations thereof. However, the present invention is not limited to such coatings, more, fewer and/or other different coatings can be used to practice the invention.

Hydrochromic inks change colors from white-to-blue, light blue-to-dark blue and/or experience other color changes when detecting moisture. Some hydrochromic inks become transparent when wet, revealing an underlying color of a surface they are a coating on, changing colors from white-to-clear and/or blue-to-clear. However, the present invention is not limited to such hydrochromic inks more, fewer and/or other different hydrochromic inks can be used to practice the invention.

Cobalt (II) chloride changes color from a blue color to a pink color when it is exposed to water and/or condensation. Cobalt (II) chloride is an inorganic compound composed of cobalt and chlorine, best known for its vivid color change in response to moisture. It serves as a chemical humidity indicator, shifting from a blue color in its anhydrous (i.e., none hydrated) form to a pink color when hydrated (i.e., absorbs moisture. The hydration transformation is reversable. The chemical formula of Cobalt (II) chloride includes CoCl₂, which is blue in color in its non-hydrated form and includes a chemical formula CoCl₂·6H₂O in a hydrated form, which is pink in color.

Cobalt (II) bromide is an inorganic chemical compound composed of cobalt and bromine, typically appearing as a red-violet color as crystalline solid and a green color when hydrated. Cobalt (II) bromide has a chemical formula of CoBr₂. When exposed to moisture, it forms hydrates such as the hexahydrate (CoBr₂·6H₂O), which exhibits distinct color changes. It serves as a chemical humidity indicator, shifting from a red-violet color in its anhydrous form to green color when hydrated. The hydration transformation is reversable.

Silica gel is a porous, granular form of silicon dioxide (SiO₂) commonly used with an indicator dye to detect moisture. Silica gel visually signals moisture absorption through a color change, which is typically orange to green to black, depending on an amount of moisture absorbed, and/or blue to pink.

Copper (II) sulfate (CuSO₄) is an inorganic compound consisting of copper, sulfur, and oxygen. Copper (II) sulfate forms crystalline solid composed of Cu²⁺ and SO₄²⁻ ions that is white in color. Upon hydration, water molecules coordinate around the Cu²⁺ ion, producing a hydrated form (CuSO₄·5H₂O), which is blue in color.

Methyl violet is a family of synthetic, triarylmethane dyes that function as humidity indicators. Methyl violet includes a white, gray or green color that changes to a violet color when it absorbs moisture.

Polymer-based moisture indicators include plastic films and/or coatings embedded with dyes that respond to water by changing color. The polymer-based moisture indicators include, but are not limited to, Hydrogel-based indicators, called swelling polymers, such as Polyacrylamide. Polyacrylamide is a synthetic water-soluble polymer made by polymerizing acrylamide monomers (C₃H₅NO). In a hydrogel form Polyacrylamide absorbs large amounts of water while maintaining structural integrity. Polyacrylamide changes color from a white color in its anhydrous form to violet and/or purple color when it absorbs moisture.

Polyvinyl alcohol (PVA) is a synthetic, water-soluble polymer with the repeating unit-CH2CHOH. It is obtained by hydrolyzing polyvinyl acetate rather than by direct polymerization of vinyl alcohol, which is unstable in monomeric form. The chemical formula of PVA includes (C₂H₄O)ₙ. PVA changes color from a white color in its anhydrous form to a green and/or purple color depending on a dye use.

However, the present invention is not limited to such moisture detection compound 20md coatings, more, fewer and/or other different coatings can be used to practice the invention.

In one embodiment, the moisture collection component 18, includes transparent, natural and/or synthetic rubber, latex, synthetic (non-latex) and/or natural membrane 18a materials and/or combinations thereof. Such materials are water-tight, stretchable and elastic. However, the present invention is not limited to such materials and more, fewer and/or other different materials can be used to practice the invention.

The synthetic (non-latex) membrane 18a materials include, but are not limited to, Polyurethane, which includes a thin plastic material and/or Polyisoprene, which includes synthetic rubber similar to latex but without latex proteins. However, the present invention is not limited to such materials and more, fewer and/or other different materials can be used to practice the invention.

The natural membrane 18a materials, include, but are not limited to, processed membranes from animals (e.g., sheep intestines, etc.). However, the present invention is not limited to such materials and more, fewer and/or other different materials can be used to practice the invention.

In one embodiment, the moisture collection component 18 includes a transparent material so the clear plastic component and/or the clear plastic window 16g of the moisture alert component 16 can be easily viewed by a user of the space below the existing fire sprinkler head 14. However, the present invention is not limited to this embodiment, and other embodiments may be used to practice the invention.

In another embodiment, the moisture collection component 18 with the transparent material has interior surfaces of the membrane component 18a coated with the moisture detecting compound 20md. In such an embodiment, the moisture alert component 16 does not include the clear plastic window 16d and does not have interior surfaces coated with the moisture detecting compound 20md. In another embodiment, both the moisture collection component 18 and the moisture alert component 16 both have interior surfaces coated with the moisture detecting compound 20md. In another embodiment, neither the moisture collection component 18 nor the moisture alert component 16 have their interior surfaces coated with the moisture detecting compound 20md. However, the present invention is not limited to these embodiments and other embodiments and/or other combinations of such embodiments may be used to practice the invention.

In one embodiment, the moisture collection component 18, collects condensation moisture or leaked water from the receptacle component 16f in the dome component 16e of the moisture alert component 16.

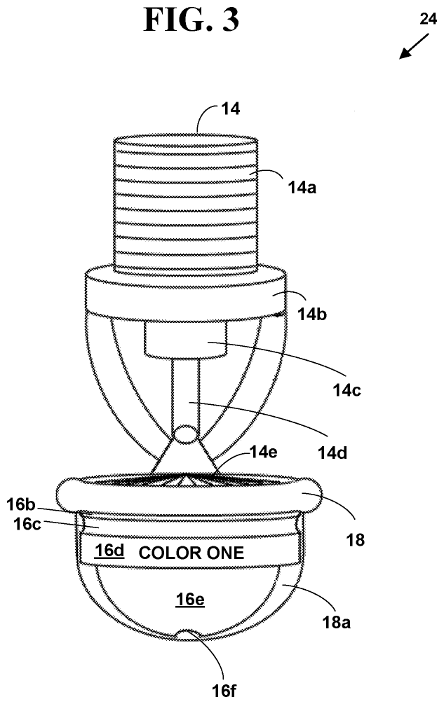

FIG. 3 is a block diagram 24 illustrating a side view of a transparent moisture collection component 18 attached to water leak alert component 16 in an exemplary fire sprinkler head moisture collection apparatus 12.

In one embodiment, the moisture collection component 18 includes but is not limited to, circular shape with pre-determined diameter of about 1.7 inches to about 2.7 inches (about 43 mm to about 68mm), a pre-determined size slightly larger than the moisture alert component 16 (FIG. 3) to engage, fit snuggly and securely around the moisture alert component 16. However, the present invention is not limited to such an embodiment, and other sizes can be used to practice the invention.

As the condensation or water leak occurs on the existing fire sprinkler heads 14, the moisture detecting compound 20md coating on the inside surface of the moisture alert component 16 changes color from a first dry color to a second wet color alerting a user of the space below the existing fire sprinkler heads 14 that condensation is occurring or water is leaking and/or as the transparent membrane 18a of the moisture collection component 18 collects moisture it expands and stretches downward from the bottom of the moisture alert component 16. Such moisture is thus collected from the existing fire sprinkler heads 14 preventing the moisture from reaching any surface below the existing fire sprinkler heads 14, protecting such surfaces from moisture and potential mold growth.

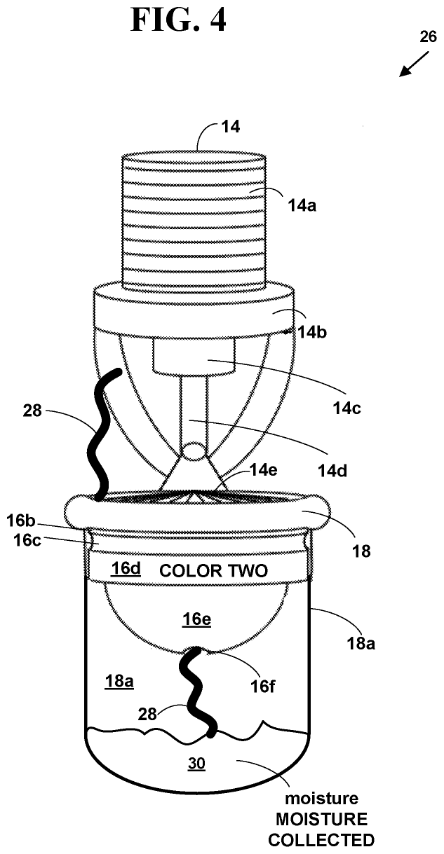

FIG. 4 is a block diagram 26 illustrating a side view of a stretched transparent membrane 18a of the moisture collection component 18 attached to moisture alert component 16 in an exemplary fire sprinkler head moisture collection apparatus 12 during a first non-fire moisture collection event on an existing fire sprinkler head 14.

In FIG. 4 in such a first non-fire event, the clear plastic component and/or the clear plastic window 16g and/or the outer surface of the moisture alert component 16 that is coated the moisture detecting compound 20md changes color when moisture 28 is detected, changes alert states from a first alert state including a first dry color state to a second alert state including a second wet color state indicating condensation is occurring or water is leaking and the transparent membrane component 18a of the moisture collection component 18 allows visual viewing of the color change and collects such moisture 30 in the transparent water-tight membrane component 18a preventing the moisture from reaching any surface below the existing fire sprinkler heads 14, protecting such surfaces from moisture and mold growth. The transparent water-tight membrane component 18a also changes states from a first collection state to a second collection state as it stretches from its original non-stretched state to is second stretched state as more and more moisture 30 is collected in the transparent water-tight membrane component 18a. A user of the space under the below the existing fire sprinkler heads 14 is alerted to such presence of moisture visually by the change in states of the color from the first dry color to the second wet color and/or the changes in states of the stretching of the transparent water-tight membrane component 18a and collection of moisture and can monitor and/or address any necessary changes required for a first non-fire event.

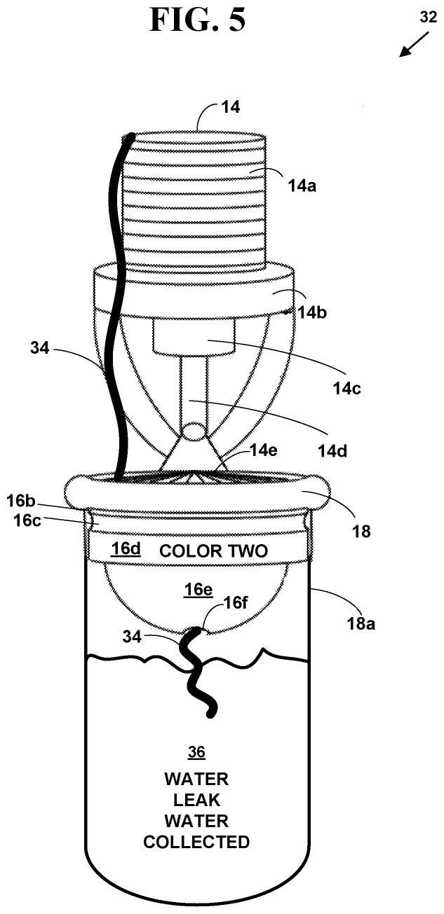

FIG. 5 is a block diagram 32 illustrating a side view of a stretched transparent membrane component 18a of the moisture collection component 18 attached to moisture alert component 16 in an exemplary fire sprinkler head moisture collection apparatus 12 during a second non-fire water leak collection event on an existing fire sprinkler head 14.

FIG. 5 in the second non-fire event, the clear plastic window 16g of the moisture alert component 16 that is coated with the moisture detecting compound 20md and/or the outer surface of the moisture alter component 16 that is coated with the moisture detecting compound 20md and/or the inside surface of the transparent membrane component 18a of the moisture collection component 18 with the moisture detecting compound 20md that changes color when moisture is detected, changing color from a first dry state color to second wet state color indicating a water leak 34 from existing fire sprinkler heads 14 and/or the transparent membrane component 18a of the moisture collection component 18 collects water 36 from the water leak and stretches and expands as it captures the water 36 from the water leak 34, preventing the water leak 34 water 36 from reaching any surface below the existing fire sprinkler heads 14, protecting such surfaces. A user of the space under the existing fire sprinkler heads 14 is alerted to such water leaks 34 from the existing fire sprinkler heads 14 by viewing the color changes and/or the expanding and stretching of transparent membrane component 18a of the moisture collection component 18 and can address the water leak 34 situation and immediately alert maintenance personnel.

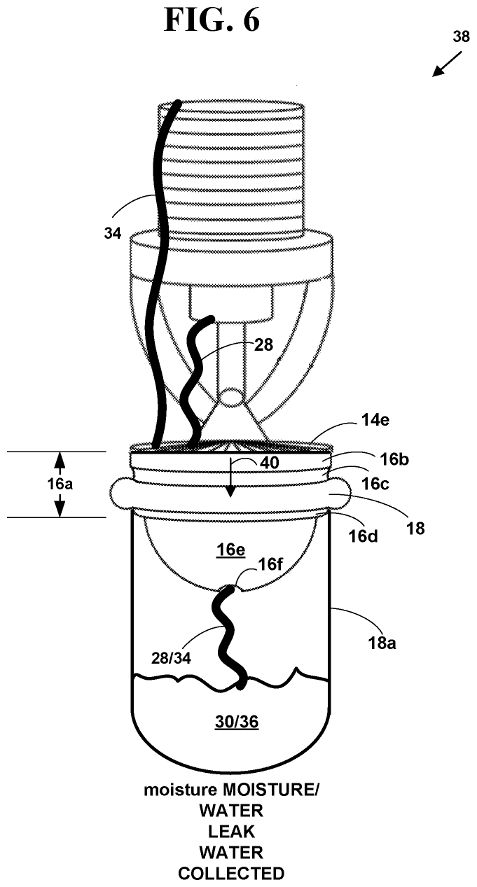

FIG. 6 is a block diagram 38 illustrating a side view of a stretched transparent membrane component 18a of the moisture collection component 18 attached to moisture alert component 16 in an exemplary fire sprinkler head moisture collection apparatus 12 during a third non-fire condensation moisture and/or water leak collection event on an existing fire sprinkler head 14.

In FIG. 6, as the transparent membrane component 18a of the moisture collection component 18 attached to moisture alert component 16 collects a pre-determined amount of condensation moisture 30 and/or water leak 34 water 36, a weight of the condensation moisture 30 and/or water leak 34 water 36 and gravity pulls the condensation moisture 30 and/or water leak 34 water 36 from the first component 16b of the flange component 16a in a downward direction 40 onto and into the second component 16c of the flange component 16, which includes the recessed grove component 16c to engage the recessed grove component 16c. This configuration allows a user to visually determine that the condensation moisture 30 and/or water leak 34 water 36 is increasing in the transparent membrane component 18a of the moisture collection component 18 and the situation has to be addressed.

In FIG. 6, the transparent membrane component 18a of the moisture collection component 18 also changes from a first collection state to a second collection state as the transparent membrane component 18a of the moisture collection component 18 slips down from the first component 16b of the flange component 16a onto the second recessed grove components 16c of the flange component 16 as the transparent membrane component 18a of the moisture collection component 18 fills with condensation moisture 30 and/or water leak 34 water 36 in increasing amounts. A difference in a static coefficient of friction between the materials that make up the transparent membrane component 18a of the moisture collection component 18 and the first component 16b of the flange component 16a onto the second recessed groove component 16c of the flange component 16 and an amount of energy required to move the transparent membrane component 18a of the moisture collection component 18 up and over an edge of the second recessed groove component 16c prevent further slippage up to a tipping point where the transparent membrane component 18a of the moisture collection component 18 collects enough condensation moisture 30 and/or water leak 34 water 36 and the weight of such moisture and/or water 36 along with a force of gravity causes the fire sprinkler head moisture collection apparatus 12 to disengage and fall off the fire sprinkler head 14.

The static coefficient of friction includes a dimensionless numerical value that represents how much two surfaces resist sliding against each other. It is commonly represented by the Greek letter μₛ (“mu”) as is illustrate by Equation (1):

μₛ=F_{f}/Fₙ, (1)

where μₛ=static coefficient of friction, F_{f}=frictional force resisting motion, Fₙ=normal force pressing two surfaces together.

The static coefficient of friction (μₛ) applies when objects are not yet moving, is usually larger than kinetic friction (when objects are moving) and represents a force needed to start a motion.

When the transparent membrane component 18a of the moisture collection component 18 collects a pre-determined amount of water, then a user can remove the whole fire sprinkler head moisture collection apparatus 12 and replace it with a whole new fire sprinkler head moisture collection apparatus 12 or simply remove and replace only the transparent membrane component 18a of the moisture collection component 18 and replace it with a new one. However, the present invention is not limited to such an embodiment and other embodiments that can be used to practice the invention.

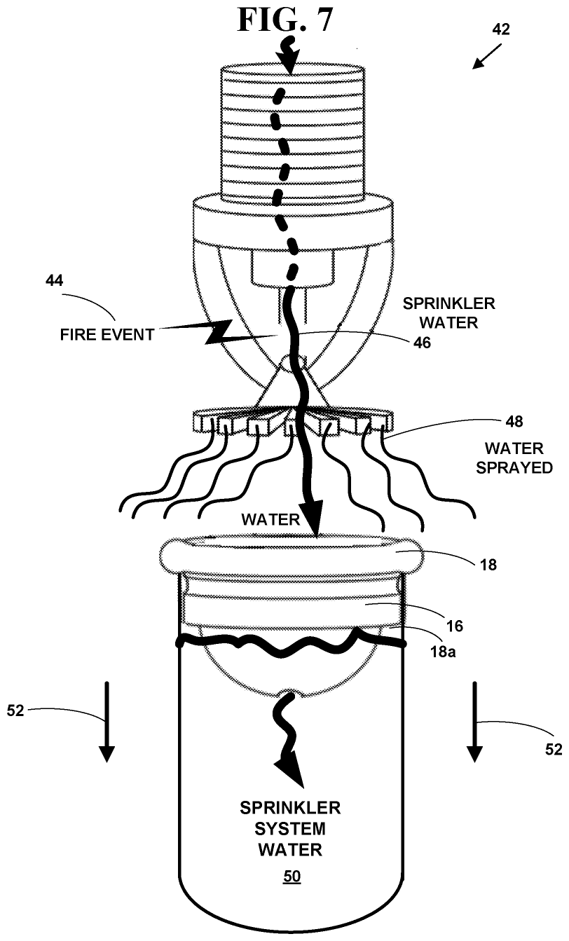

FIG. 7 is a block diagram 42 illustrating a side view of transparent membrane component 18a of the moisture collection component 18 attached to moisture alert component 16 in an exemplary fire sprinkler head moisture collection apparatus 12 during a fire event 44 on an existing fire sprinkler head 14.

In FIG. 7 in such a fire event 44, a fire sprinkler head 14 that includes the fire sprinkler head moisture collection apparatus 12 is heated and the temperature-sensitive trigger component 14d is triggered. Once the glass bulb shatters and/or the metal fusible link melts off the temperature-sensitive trigger component 14d, water pressure water pushes the plug seal component 14c out and a pressured water stream 46 flows immediately from the pressured water system in a downward direction via gravity. The pressured water stream 46 hits the deflector component 14e and spreads the water in a specific spray pattern 48 to cool fire, wet the materials under the fire sprinkler head 14 and prevent the fire from spreading.

In such a fire event 44, with the fire sprinkler head 14 that does include the fire sprinkler head moisture collection apparatus 12, the moisture collection component 18 would immediately (i.e., within one second or less, etc.) fill with sprinkler system water 46 and a weight of the water 50 and gravity would immediately cause the whole the fire sprinkler head moisture collection apparatus 12 to be immediately jettisoned 52 (i.e., within one second or less, etc.) and forced off a corresponding existing fire sprinkler head 14 to which the fire sprinkler head moisture collection apparatus 12 was attached without interfering with water deflection via the deflector component 14e. In such a fire event 44, the fire sprinkler head moisture collection apparatus 12 would fall down onto a surface below the fire sprinkler head 14.

FIGS. 1-7 illustrate the fire sprinkler head 14 placed the ceiling of the space in a vertical configuration facing downward from the ceiling in the space. However, present invention is not limited to such an embodiment and other embodiment may be used to practice the invention.

In another embodiment the fire sprinkler head 14 is placed on vertical walls in the space instead of on a ceiling and exists in a horizontal configuration. However, present invention is not limited to such an embodiment and other embodiment may be used to practice the invention.

In such an embodiment, where the fire sprinkler heads 14 are placed on vertical walls in the space instead of the ceiling in the space, the moisture collection component 18 of the fire sprinkler head moisture collection apparatus 12 sticks out horizontally from the vertical walls and will stretch in a horizontal (i.e., out, etc.) direction first, then in a vertical direction (i.e., down, etc.) based on an amount and weight of condensation moisture 30 and/or water leak 34 water 36 collected and the force of gravity.

Components of the fire sprinkler head moisture collection apparatus 12 are individually manufactured, machined, three-dimensional (3D) printed by a 3D printer, extruded and/or pultruded including cardboard, paper, metal, rubber, wood, plastic and/or composite materials and/or combinations thereof. However, the present invention is not limited to such an embodiment and other embodiments with other manufacturing processes and other materials can be used to practice the invention.

In one embodiment, components 16, 18 of the fire sprinkler head moisture collection apparatus 12 are manufactured, machined, 3D printed by a 3D printer, injection molded, vacuum formed, extruded and/or pultruded as multiple components and/or as a one-piece integral unit. In one embodiment, component 16 of the fire sprinkler head moisture collection apparatus 12 is manufactured, machined, 3D printed by a 3D printer, extruded and/or pultruded, or a combination thereof, separately and is assembled into the fire sprinkler head moisture collection apparatus 12. In one embodiment, component 18 of the fire sprinkler head moisture collection apparatus 12 is manufactured and is assembled into the fire sprinkler head moisture collection apparatus 12. However, the present invention is not limited to such embodiments and other embodiments may be used to practice the invention.

“Manufacturing” includes the process of making items from raw materials. “Machining” includes various processes in which a piece of raw material is cut into a desired final shape and size by a controlled manufacturing process and/or a material-removal process.

A “3D printer” includes 3D printing or “Additive manufacturing.” 3D printing is a process of making a three-dimensional solid object of virtually any shape from a digital model. 3D printing is achieved using an “additive process,” where successive layers of material (e.g., metal, plastic, etc.) are laid down in different shapes. 3D printing is also considered distinct from traditional manufacturing and/or machining techniques, which mostly rely on the removal of material by methods such as cutting or drilling and are “subtractive” processes.

In one embodiment, the 3D printing process includes a Fused Deposition Modeling (FDM) 3D printing process and/or a Stereolithography (SLA) 3D printing process. FDM technology includes a process of making physical objects by building up successive layers of material with an extruded thermoplastic filament. SLA technology includes a form of 3D printing technology used for creating models, prototypes, patterns, and production parts in a layer-by-layer fashion using photochemical processes by which light causes chemical monomers and oligomers to cross-link together to form polymers to create physical objects. However, the present invention is not limited to these 3D printing processes and other 3D printing processes can be used to practice the invention.

“Injection molding” includes a manufacturing process for producing parts by injecting molten material into a mold, or mould. Injection molding can be performed with a host of materials mainly including metals, glasses, elastomers, confections, and most commonly thermoplastic and thermosetting polymers.

“Vacuum forming” includes a manufacturing process for producing parts by simplified version of thermoforming, where a sheet of plastic is heated to a forming temperature, stretched onto a single-surface mold, and forced against the mold by a vacuum. This process can be used to form plastic into permanent objects.

“Extrusion” is a manufacturing process where a material such as aluminum, plastic, etc. is pushed and/or drawn through a die to create long objects of a fixed cross-section. Hollow sections are usually extruded by placing a pin or mandrel in the die. Extrusion may be continuous (e.g., producing indefinitely long material) or semi-continuous (e.g., repeatedly producing many shorter pieces). Some extruded materials are hot drawn and others may be cold drawn.

The feedstock may be forced through the die by various methods: by an auger, which can be single or twin screw, powered by an electric motor; by a ram, driven by hydraulic pressure, oil pressure or in other specialized processes such as rollers inside a perforated drum for the production of many simultaneous streams of material.

“Pultrusion” is a manufacturing process for producing continuous lengths of materials. Pultrusion raw materials include metals such as aluminum, etc. or a liquid resin mixture (e.g., containing resin, fillers and specialized additives) and reinforcing fibers (e.g., fiberglass, composite materials, etc.). The process involves pulling these raw materials (rather than pushing as is the case in extrusion) through a heated steel forming die using a continuous pulling device. The reinforcement materials are in continuous forms such as rolls of fiberglass mat or doffs of fiberglass roving. As the reinforcements are saturated with the resin mixture in the resin impregnator and pulled through the die, the gelation (or hardening) of the resin is initiated by the heat from the die and a rigid, cured profile is formed that corresponds to the shape of the die.

There are also pultruded laminates. Most pultruded laminates are formed using rovings aligned down the major axis of the part. Various continuous strand mats, fabrics (e.g., braided, woven and knitted), and texturized or bulked rovings are used to obtain strength in the cross axis or transverse direction.

The pultrusion process is normally continuous and highly automated. Reinforcement materials, such as roving, mat or fabrics, are positioned in a specific location using preforming shapers or guides to form a pultrusion. The reinforcements are drawn through a resin bath where the material is thoroughly coated or impregnated with a liquid thermosetting resin. The resin-saturated reinforcements enter a heated metal pultrusion die. The dimensions and shape of the die define the finished part being fabricated. Inside the metal die, heat is transferred initiated by precise temperature control to the reinforcements and liquid resin. The heat energy activates the curing or polymerization of the thermoset resin changing it from a liquid to a solid. The solid laminate emerges from the pultrusion die to the exact shape of the die cavity. The laminate solidifies when cooled and it is continuously pulled through the pultrusion machine and cut to the desired length. The process is driven by a system of caterpillar or tandem pullers located between the die exit and the cut-off mechanism.

A “composite material” is a combination of two materials with different physical and chemical properties. The different physical or chemical properties of the two materials remain separate and distinct at the macroscopic or microscopic scale within the finished structure. Common polymer-based composite materials, include at least two parts, a substrate (e.g., fibers, etc.) and a resin.

When the two materials are combined, they create a composite material which is specialized material to do a certain job, for instance to become stronger, lighter or resistant to electricity. Composite materials also improve strength and stiffness of the materials. One reason for their use over traditional materials is because they improve the properties of their base materials and are applicable in many situations.

The composite materials include, but are not limited to, “Fiber-reinforced polymers” (FRP) including thermoplastic composites, short fiber thermoplastics, long fiber thermoplastics or long fiber-reinforced thermoplastics. There are numerous thermoset composites, but advanced systems usually incorporate aramid fiber and carbon fiber in an epoxy resin matrix. The composite materials also include carbon/carbon composite materials with carbon fibers and a silicon carbide matrix.

However, the present invention is not limited to such embodiments and other embodiments and other processes and materials may be used to practice the invention.

### Fire Sprinkler Head Moisture Collection Apparatus Method of Use

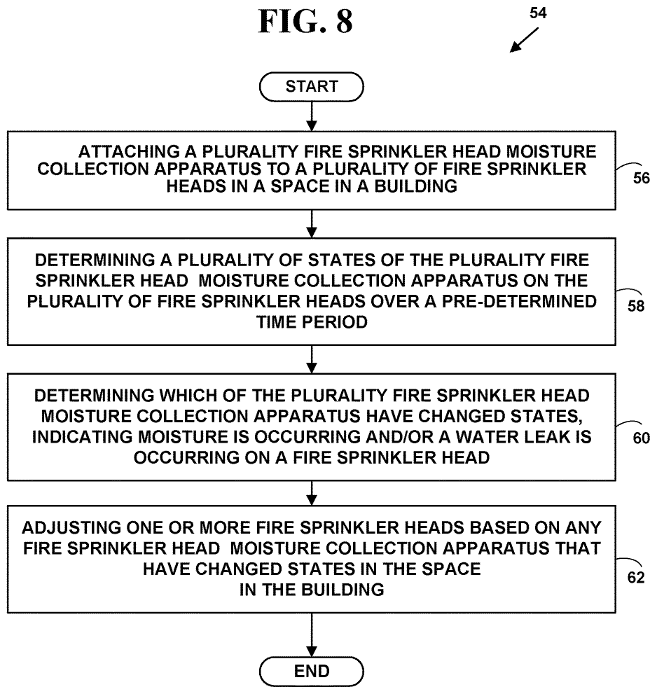

FIG. 8 is a flow diagram illustrating a Method 54 of use of a fire sprinkler head moisture collection apparatus 12.

In FIG. 8 at Step 56, attaching a plurality fire sprinkler head moisture collection apparatus to a plurality of fire sprinkler heads in a space in a building. Step 58, determining a plurality of states of the plurality fire sprinkler head moisture collection apparatus on the plurality of fire sprinkler heads over a pre-determined time period. At Step 60, determining which of the plurality fire sprinkler head moisture collection apparatus have changed states, indicating condensation is occurring and/or a water leak is occurring on a fire sprinkler head. At Step 62, adjusting one or more fire sprinkler heads based on any fire sprinkler head moisture collection apparatus that have changed states.

Method 54 is illustrated with an illustrative embodiment. However, the present invention is not limited to this illustrative embodiment and other embodiments can be used to practice the invention.

In such an illustrative embodiment, at Step 56, attaching a plurality fire sprinkler head moisture collection apparatus 12 to a plurality of fire sprinkler heads 14 in a space in a building.

At Step 58, determining a plurality of states of the plurality fire sprinkler head moisture collection apparatus 12 on the plurality of fire sprinkler heads 14 over a pre-determined time period.

In one embodiment, the pre-determined time period includes a one week and/or one month time period. However, the present invention is not limited to such time periods and other time periods can be used to practice the invention.

At Step 60, determining which of the plurality fire sprinkler head moisture collection apparatus 12 have changed states, indicating condensation 26 is occurring and/or a water leak 32 is occurring on a fire sprinkler head 14.

In one embodiment, the change in states include one or more of: (1) a change in color in the moisture alert component 16 and/or the moisture collection component 18; and/or (2) a change in physical size including, but is not limited to, stretching and elongation of the moisture collection component 18.

In one embodiment, such change in states is observed visually by a user of the space in the building and/or by maintenance personnel of the space in the building. However, the present invention is not limited to visual observations and other methods and other embodiments can be used to practice the invention.

In another embodiment, the moisture alert component 16 and/or the moisture collection component 18 includes a Radio Frequency IDentifier (RFID) tag and/or other sensor with a moisture detector that is activated when moisture is detected. In such an embodiment, the RFID tag information is automatically transmitted with a radio frequency signal to a software application on a network device (e.g., smart phone, electronic tablet, computer, wearable (e.g. watch, bracelet, glasses, ring, etc.) with one or more processors via a wireless communications network. In this embodiment, changes are state of the fire sprinkler head moisture collection apparatus 12 are reported automatically by the RFID tag and/or other sensor with the moisture detector and visual observation is not necessary but is used to observe and confirm changes in states of the fire sprinkler head moisture collection apparatus 12. However, the present invention is not limited such an embodiment and other embodiments can be used to practice the invention.

In one embodiment, moisture sensing RFID tags by the BRADY® Company, passive moisture sensing RFID tags, by HID® Corporation, and/or other moisture sensing RFID tags are used. However, the present invention is not limited to such embodiment, and other moisture sensing RFID Tags can be used to practice the invention.

At Step 62, adjusting one or more fire sprinkler heads 14 based on any fire sprinkler head moisture collection apparatus 12 that have changed states in the space in the building.

In one embodiment, the adjusting includes, but is not limited to, changing temperature and humidity in the space in the building to prevent condensation on the fire sprinkler heads 14 and/or fixing the fire sprinkler heads that are leaking and/or replacing the fire sprinkler heads 14 that are leaking. However, the present invention is not limited to such embodiments, and other embodiments can be used to practice the invention.

A fire sprinkler head moisture collection apparatus and method of use is presented herein. The apparatus includes a water leak alert component and a moisture collection component. The moisture alert component alerts a user that condensation is forming on the fire sprinkler head or that water is leaking from the fire sprinkler head with a change in color or via condensation or water leaking from the fire sprinkler head causing a change in state (e.g., stretches in length, etc.). The moisture collection components collect condensation and water that is leaking from fire sprinkler heads. The apparatus is attached to fire sprinkler heads without interfering with an operation the fire sprinkler head in a fire event requiring use of the fire sprinkler head.

It should be understood that the architecture, materials, processes, methods, apparatus and systems described herein are not related or limited to any particular type of architecture, materials, processes, methods, apparatus and systems unless indicated otherwise. Various types of general purpose or specialized architecture, materials, processes, methods and systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more, fewer or other elements may be used in the block diagrams.

The claims should not be read as limited to the described order or elements unless stated to that effect. In addition, use of the term “means” in any claim is intended to invoke 35 U.S.C. § 112, paragraph 6, and any claim without the word “means” is not so intended. Therefore, all embodiments that come within the scope and spirit of the following claims and equivalents thereto are claimed as the invention.

I claim:

1. A fire sprinkler head moisture collection apparatus, comprising in combination:
a moisture alert component, configured for collecting condensation moisture and leaked water from a fire sprinkler head, comprising:
a flange component of a pre-determined diameter, length, width, shape and material to fit on a bottom portion of a deflector component on the fire sprinkler head,
the flange component including a first section, a second section and a third section, the second section including a recessed surface comprising a groove component,
the flange component further including a dome component for directing the condensation moisture and the leaked water from the fire sprinkler head into a receptacle component extending through a bottom surface of the dome component;
the receptacle component for directing the condensation moisture and the leaked water from the fire sprinkler head into a moisture collection component,
the moisture alert component changing from a first alert state to a second alert state when condensation moisture or leaked water is received from the fire sprinkler head;
the moisture collection component, configured for collecting the condensation moisture and the leaked water from the receptacle component of the moisture alert component, comprising:
a transparent water-tight, stretchable, elastic membrane configured for collecting and holding the condensation moisture and the leaked water from the receptacle component of the moisture alert component,
the moisture collection component changing from a first collection state to a second collection state when the condensation moisture or the leaked water is collected from the receptacle of the moisture alert component,
the moisture collection component changing from the first collection state to the second collection state without interfering with the operation of the deflector component during a fire event in a first space underneath the fire sprinkler head;
a moisture detecting compound changing states upon detecting the condensation moisture or the leaked water from the fire sprinkler head; and
the moisture alert component and moisture collection component changing states upon receiving the condensation moisture or the leaked water from the fire sprinkler head without interfering with the operation of the deflector component during non-fire events of the fire sprinkler head, and
the moisture alert component and the moisture collection component collecting the condensation moisture or the leaked water from the fire sprinkler head preventing the first space underneath the fire sprinkler head from becoming wet and creating first environmental space in which one or more species of mold can grow,
and preventing a second space around the fire sprinkler head from becoming wet and creating a second environmental space in which one or more species of mold can grow,
the moisture alert component attachable to and removeable from the deflector component of the fire sprinkler head component without interfering with an operation of the deflector component during the fire event in the first space underneath the fire sprinkler head.

2. The fire sprinkler head moisture collection apparatus of claim 1, further comprising:
the first alert state of the moisture alert component including the moisture collection component fully covering all three sections of the flange of the moisture alert component, when no condensation moisture or leaked water has been detected from the fire sprinkler head; and
the second alert state of the moisture alert component including the moisture collection component partially covering all three sections of the flange of moisture alert component indicating that condensation moisture or leaked water has been detected from the fire sprinkler head.

3. The fire sprinkler head moisture collection apparatus of claim 2, wherein
the second alert state including movement of the moisture collection component in a downwards direction from engaging the first section of the flange of the moisture alert component to engaging the second section of the flange including the recessed surface comprising the groove component when condensation moisture or leaked water from the fire sprinkler head is collected within the moisture collection component,
the second section of the flange including the recessed surface comprising the groove component providing a second attachment surface for the second alert state on the flange that is resistant to further downward movement of the moisture collection component on the flange of the moisture alert component.

4. The fire sprinkler head moisture collection apparatus of claim 1, further comprising:
coating an outer surface of the moisture alert component with a moisture detecting compound, the moisture detecting compound including a first color component indicating no condensation moisture or leaked water has been detected from the fire sprinkler head and a second color indicating that condensation moisture or leaked water has been detected from the fire sprinkler head,
the first alert state of the moisture alert component including the first color of the moisture detecting compound visible on the outer surface of the moisture detecting component through the transparent membrane of the moisture collection component indicating no condensation moisture or leaked water has been detected on the outer surface of the moisture alert component from the fire sprinkler head, and
the second alert state of the moisture alert component including the second color of the moisture detecting compound visible on the outer surface of the moisture detecting compound through the transparent membrane of the moisture collection component indicating that condensation moisture or leaked water has been detected on the outer surface of the moisture alert component from the fire sprinkler head.

5. The fire sprinkler head moisture collection apparatus of claim 1, further comprising:
adding a fabric material component coated with the moisture detecting compound to the first section or the third section of the flange component of the moisture alert component;
the moisture detecting compound including a first color component indicating no condensation moisture or leaked water has been detected from the fire sprinkler head and a second color indicating that condensation moisture or leaked water has been detected from the fire sprinkler head,
the first alert state of the moisture alert component including the first color of the moisture detecting compound visible on the outer surface of the moisture detecting component through the transparent membrane of the moisture collection component indicating no condensation moisture or leaked water has been detected on the outer surface of the moisture alert component from the fire sprinkler head, and
the second alert state of the moisture alert component including the second color of the moisture detecting compound visible on the outer surface of the moisture detecting compound through the transparent membrane of the moisture collection component indicating that condensation moisture or leaked water has been detected on the outer surface of the moisture alert component from the fire sprinkler head.

6. The fire sprinkler head moisture collection apparatus of claim 1, further comprising:
the first collection state of the moisture collection component including a visible unstretched state of the transparent membrane component on the moisture collection component; and
the second collection state of the moisture collection component including a visible stretched state of the transparent membrane component of the moisture collection component.

7. The fire sprinkler head moisture collection apparatus of claim 1, further comprising:
coating an inner surface of the transparent membrane component of the moisture collection component with the moisture detecting compound, the moisture detecting compound including a first color indicating no condensation moisture or leaked water has been detected from the fire sprinkler head and a second color indicating that condensation moisture or leaked water has been detected from the fire sprinkler head,
the first collection state of the moisture collection component including the first color of the moisture detecting compound visible on the inner surface of inner surface of the transparent membrane component of the moisture collection component indicating no condensation moisture or leaked water has been detected on the outer surface of the moisture alert component from the fire sprinkler head, and
the second collection state of the moisture alert component including the second color of the moisture detecting compound visible on the inner surface of the inner surface of the transparent membrane component of the moisture collection component indicating that condensation moisture or leaked water has been detected on the inner surface of the moisture collection component inner surface of the transparent membrane component of the moisture collection component from the fire sprinkler head.

8. The fire sprinkler head moisture collection apparatus of claim 1, wherein the moisture detecting compound includes: a hydrochromic ink, Cobalt (II) chloride, Cobalt (II) bromide, Silica gel, Copper (II) Sulfate, methyl violet, hydrogel polymers, polyvinyl alcohol or cellulose, moisture detecting compound, or combinations thereof.

9. The fire sprinkler head moisture collection apparatus of claim 1, wherein the moisture alert component includes: a wood, rubber, paper, plastic, composite material, or combinations thereof.

10. The fire sprinkler head moisture collection apparatus of claim 9, wherein the plastic includes: a Polyvinyl chloride (PVC), Very low-density polyethylene (VLDPE), Flexible polypropylene (FPP), Ethylene interpolymer alloy (EIA), or ethylene propylene diene monomer (EPDM), plastic, or combinations thereof.

11. The fire sprinkler head moisture collection apparatus of claim 9, wherein composite material include: Fiber-reinforced polymers (FRP) including thermoplastic composites, short fiber thermoplastics, long fiber thermoplastics or long fiber-reinforced thermoplastics, carbon or carbon fiber materials, or combinations thereof.

12. The fire sprinkler head moisture collection apparatus of claim 1, wherein the transparent membrane component of the moisture collection component includes: a natural rubber, synthetic rubber, latex, or synthetic non-latex, transparent membrane, or combinations thereof.

13. The fire sprinkler head moisture collection apparatus of claim 1, wherein the pre-determined diameter of the flange component of the moisture alert component includes a diameter of about 1.6 inches to about 2.6 inches (about 40.64 millimeters (mm) to about 66.04 mm) the pre-determined length of the flange component of the moisture alert component includes a width of about 1.7 inches to about 2.7 inches (about 43.18 mm to about 68.58 mm) and the pre-determined width of the flange component of the moisture alert component includes a length of about 11/16 inches (0.6875 inches or about 17.46 mm) and the pre-determined shape of the flange component of the moisture alert component includes a circular shape or an oval shape.

14. The fire sprinkler head moisture collection apparatus of claim 1, wherein flange component and the dome component of the moisture alert component include: a wood, rubber, plastic, paper or composite material, or combinations thereof.

15. The fire sprinkler head moisture collection apparatus of claim 1, wherein the leak alert dome component of the moisture alert component includes a width of about three-fourth inches (0.75 inches or about 19 millimeters (mm)) and a length of about 1.6 inches to about 2.6 inches (about 40.64 mm to about 66.04 mm).

16. The fire sprinkler head moisture collection apparatus of claim 1, wherein the moisture alert component and the moisture collection component are individually manufactured, machined, three-dimensional (3D) printed by a 3D printer, injection molded, vacuum formed, extruded or pultruded.

17. The fire sprinkler head moisture collection apparatus of claim 1, wherein the moisture alert component or the moisture collection component includes a radio frequency identifier (RFID) tag or other sensor with a moisture detector that is activated when moisture is detected.

18. The fire sprinkler head moisture collection apparatus of claim 1, wherein the RFID tag or other sensor with moisture detector automatically transmits a radio frequency signal to a software application on a network device with one or more processors via a wireless communications network to indicate that moisture has been detected on fire sprinkler head moisture collection apparatus.

19. A method for determining condensation moisture or leaked water from a fire sprinkler head, comprising:
attaching a plurality of fire sprinkler head moisture collection apparatus to a plurality of fire sprinkler heads in a space in a building;
determining visually over a pre-determined time period if any of fire sprinkler head moisture collection apparatus on the plurality of fire sprinkler heads have changed states, indicating a condensation is occurring on one or more individual fire sprinkler heads from the plurality of fire sprinkler heads or a water leak is occurring on the one or more individual fire sprinkler heads from the plurality of fire sprinkler heads;
removing and disposing the one or more selected fire sprinkler head moisture collection apparatus on the one or more individual fire sprinkler heads from the plurality of fire sprinkler heads where a change in state has occurred;
correcting the condensation occurring or the water leaks occurring on the one or more individual fire sprinkler heads from the plurality of fire sprinkler heads where a change in state has occurred; and
attaching a new fire sprinkler head moisture collection apparatus on the one or more individual fire sprinkler heads where a change in state had occurred to again detecting and condensation occurring or water leaks occurring on the one or more individual fire sprinkler heads from the plurality of fire sprinkler heads in the space in the building.

20. The method of claim 19, wherein the plurality of fire sprinkler head moisture collection apparatus includes:
a moisture alert component, configured for collecting condensation moisture and leaked water from a fire sprinkler head, comprising:
a flange component of a pre-determined diameter, length, width, shape and material to fit on a bottom portion of a deflector component on the fire sprinkler head,
the flange component including a first section, a second section and a third section, the second section including a recessed surface comprising a groove component,
the flange component further including a dome component for directing the condensation moisture and the leaked water from the fire sprinkler head into a receptacle component extending through a bottom surface of the dome component;
the receptacle component for directing the condensation moisture and the leaked water from the fire sprinkler head into a moisture collection component,
the moisture alert component changing from a first alert state to a second alert state when condensation moisture or leaked water is received from the fire sprinkler head;
the moisture collection component, configured for collecting the condensation moisture and the leaked water from the receptacle component of the moisture alert component, comprising:
a transparent water-tight, stretchable, elastic membrane configured for collecting and holding the condensation moisture and the leaked water from the receptacle component of the moisture alert component,
the moisture collection component changing from a first collection state to a second collection state when the condensation moisture or the leaked water is collected from the receptacle of the moisture alert component,
the moisture collection component changing from the first collection state to the second collection state without interfering with the operation of the deflector component during a fire event in a first space underneath the fire sprinkler head;
a moisture detecting compound changing states upon detecting the condensation moisture or the leaked water from the fire sprinkler head; and
the moisture alert component and moisture collection component changing states upon receiving the condensation moisture or the leaked water from the fire sprinkler head without interfering with the operation of the deflector component during non-fire events of the fire sprinkler head, and
the moisture alert component and the moisture collection component collecting the condensation moisture or the leaked water from the fire sprinkler head preventing the first space underneath the fire sprinkler head from becoming wet and creating first environmental space in which one or more species of mold can grow,
and preventing a second space around the fire sprinkler head from becoming wet and creating a second environmental space in which one or more species of mold can grow,
the moisture alert component attachable to and removeable from the deflector component of the fire sprinkler head component without interfering with an operation of the deflector component during the fire event in the first space underneath the fire sprinkler head.
